(19) United States
(12) Patent Application Publication
(10) Pub. No.: US 2011/0176268 A1
(43) Pub. Date: Jul. 21, 2011

(54) ALL-IN-ONE DESKTOP COMPUTER

(76) Inventors: Yen KUANG, Taipei City (TW); Wei-Chih LAI, Taipei City (TW)

(21) Appl. No.: 13/005,983

(22) Filed: Jan. 13, 2011

(30) Foreign Application Priority Data
Jan. 15, 2010 (TW) 099200922

(51) Int. Cl. G06F 1/16

(52) U.S. Cl. 361/679.22

(57) ABSTRACT

An all-in-one desktop computer includes a display module, a holding body, a main assembly, and a back cover. The holding body is disposed on one side of the display module. The main assembly is disposed at the holding body. The back cover and the holding body are disposed on the same side of the display module, and the back cover covers the holding body and the main assembly. According to the all-in-one desktop computer, the main assembly is disposed at the holding body to position and fix the main assembly and to strengthen structure stability of the all-in-one desktop computer.

### CROSS REFERENCE TO RELATED APPLICATIONS

This Non-provisional application claims priority under 35 U.S.C. §119(a) on Patent Application No(s). 099200922 filed in Taiwan, Republic of China on Jan. 15, 2010, the entire contents of which are hereby incorporated by reference.

### BACKGROUND OF THE INVENTION

1. Field of Invention

This invention relates to a desktop computer and, more particularly, to an all-in-one desktop computer.

2. Related Art

Currently, the users can use computers to deal with word documents or to get the latest information, and communicate with others and even can buy everything via the Internet. Thereby, the computer gradually becomes necessary objects for persons and companies.

FIG. 1 is a schematic diagram showing a conventional desktop computer. In FIG. 1, a desktop computer 1 has a display device 11 and a main body 12. The main body 12 may have components such as a motherboard, a central processing unit (CPU), a hard disk drive, a heat sink (the above components are not shown), an optical disk drive 121 and so on, and the components are disposed in a casing 122. The main body 12 is further connected with the display device 11 via a wire.

However, the display device 11 and the main body 12 of the conventional desktop computer 1 are different components independent of each other. Thus, the desktop computer 1 has great volume and occupies space, thereby causing inconvenience for a user to use and place the desktop computer 1.

### SUMMARY OF THE INVENTION

According to the above, this invention is to provide an all-in-one desktop computer. Volume of a desktop computer is reduced, and a main assembly is disposed at a holding body to strengthen structure stability of the all-in-one desktop computer.

An all-in-one desktop computer in the invention includes a display module, a holding body, a main assembly, and a back cover. The holding body is disposed on one side of the display module. The main assembly is disposed at the holding body. The back cover and the holding body are disposed on the same side of the display module, and the back cover covers the holding body and the main assembly.

In one embodiment of the invention, the all-in-one desktop computer may further include a front cover disposed on the other side of the display module, and the front cover may be assembled with the back cover.

In one embodiment of the invention, the main assembly may have a motherboard, a data storage device, an optical disk drive, and at least one heat dissipating element. Further, the holding body has a plurality of displacement portions, and the displacement portions correspond to the data storage device and the optical disk drive, respectively. In addition, the holding body has a containing portion, and the containing portion contains the motherboard, the data storage device, the optical disk drive, and the heat dissipating element.

In one embodiment of the invention, the all-in-one desktop computer may further include a supporting element connected with the back cover.

To sum up, according to the all-in-one desktop computer in the invention, the volume of the desktop computer can be reduced, and the main assembly is disposed at the holding body to strengthen the structure stability of the all-in-one desktop computer. Further, the main assembly is effectively prevented from external electromagnetic interference (EMI) by the holding body. Thus, additional metal elements are not needed to prevent the EMI of the different electronic components.

Furthermore, the holding body has a plurality of the displacement portions and the containing portion. The containing portion positions and fixes the different electronic components of the main assembly and avoids affecting the position of the main assembly relative to the holding body. The different electronic components of the main assembly is dissembled or replaced conveniently by the displacement portions. Since the main assembly is fixed relative to the holding body, the display module only needs to be fixed to the main assembly and the holding body, and then the front cover is combined with the back cover to cover the display module, the holding body, and the main assembly. Thereby, time for assembling the all-in-one desktop computer is greatly reduced thus to improve the assembling efficiency.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional desktop computer;

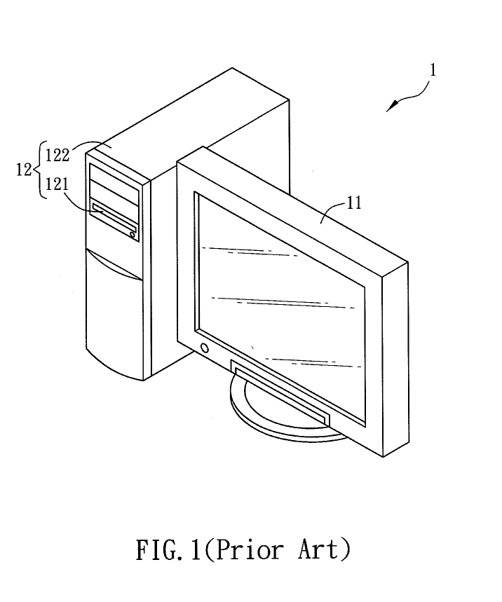

FIG. 2 is a schematic diagram showing an all-in-one desktop computer according to one preferred embodiment of the invention;

FIG. 3 is an exploded diagram showing an all-in-one desktop computer according to one preferred embodiment of the invention;

FIG. 4 is a schematic diagram showing a main assembly and a holding body according to one preferred embodiment of the invention; and

FIG. 5 is a back view showing an all-in-one desktop computer according to one preferred embodiment of the invention.

### DETAILED DESCRIPTION OF THE INVENTION

An all-in-one desktop computer in preferred embodiments of this invention is described hereinbelow according to related drawings, and the same elements are marked by the same reference numbers.

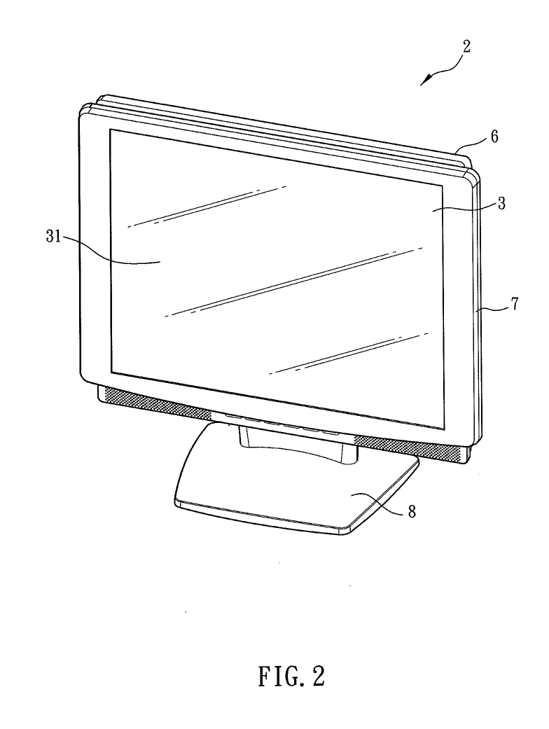

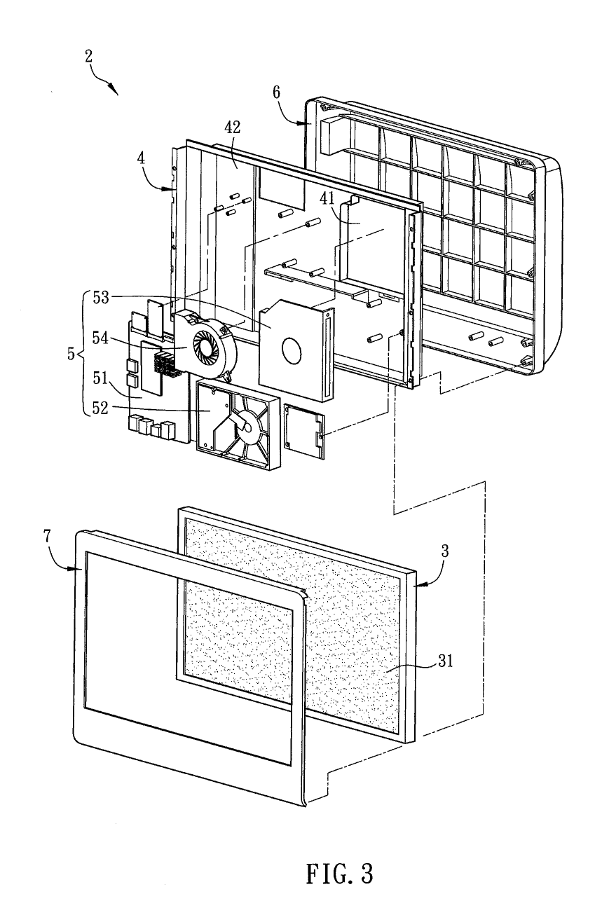

Please refer to FIG. 2 and FIG. 3 together. FIG. 2 is a schematic diagram showing an all-in-one desktop computer according to one preferred embodiment of the invention. FIG. 3 is an exploded diagram showing an all-in-one desktop computer according to one preferred embodiment of the invention. The all-in-one desktop computer may have a supporting element according to actual needs. However, for clearly illustration, the supporting element is not shown in FIG. 3. An all-in-one desktop computer 2 in the embodiment includes a display module 3, a holding body 4, a main assembly 5, and a back cover 6.

The display module 3 may be a liquid crystal display (LCD) module, a light-emitting diode (LED) display module, an organic light-emitting display (OLED) module, a field emission display (FED) module, or a plasma display panel (PDP) module. If the display module 3 is an LCD module, the display module 3 further has a display panel 31 and a backlight unit (not shown), and the backlight unit is disposed adjacent to the display panel 31. The backlight unit may have a back plate and a light source, and the light source is disposed at the back plate.

The holding body 4 is disposed on one side of the display module 3. In the embodiment, the holding body 4 may be a casing and may have a containing portion 42. However, the invention is not limited thereto. The holding body 4 may also be a plate or may have other shapes. Further, the holding body 4 may be made of metal.

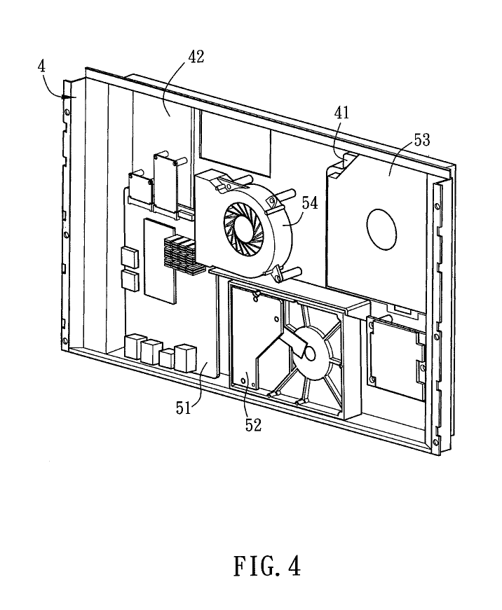

Please refer to FIG. 3 and FIG. 4 together. FIG. 4 is a schematic diagram showing a main assembly and a holding body according to one preferred embodiment of the invention. The main assembly 5 is disposed at the holding body 4, and the main assembly 5 is disposed between the holding body 4 and the display module 3. That is, the holding body 4 and the display module 3 are disposed on two opposite sides of the main assembly 5, respectively. The main assembly 5 in the embodiment may have a motherboard 51, a data storage device 52, an optical disk drive 53, and at least one heat dissipating element 54. The motherboard 51 may have a central processing unit, a chipset, a universal serial bus (USB) connecting port, a card reading port, an audio input/output port, an input interface connecting port, a network connecting port, or a combination thereof. The data storage device 52 may be a hard disk drive (HDD) or a solid state drive (SSD). Further, according to different specification, the data storage device 52 may be a hard disk drive in different sizes such as 1.8-inch, 2.5-inch, or 3.5-inch. The optical disk drive 53 may be a CD-ROM optical disk drive (ODD), a CD-R ODD, a CD-RW ODD, a DVD-ROM ODD, a DVD-R ODD, a blue-ray disk (BD) ODD and so on. The heat dissipating element 54 may have a heat dissipating fan, a heat dissipating film, a heat dissipating plate, a heat dissipating fin, a heat pipe, or a combination thereof.

In the embodiment, the motherboard 51, the data storage device 52, the optical disk drive 53, and the heat dissipating element 54 are contained in the containing portion 42 of the holding body 4. Thereby, positions of the electronic components of the main assembly 5 is fixed relative to the holding body 4 for preventing from being affected by shaking or hitting.

In addition, in the embodiment, the holding body 4 has a plurality of displacement portions 41. However, the invention is not limited thereto. The displacement portions 41 correspond to a part of the electronic components of the main assembly 5, such as the data storage device 52 or the optical disk drive 53. The displacement portions 41 may be openings or sliding grooves. In the embodiment, the displacement portions 41 as openings are taken for example, and the shape of the openings corresponds to that of the electronic components disposed at the displacement portions 41, thereby facilitating disassembling or replacing the electronic components disposed at the displacement portions 41.

The back cover 6 may be made of plastic or metal and is disposed on the other side of the holding body 4 opposite to the main assembly 5. That is, the back cover 6 and the holding body 4 are disposed on the same side of the display module 3. The back cover 6 covers the holding body 4 and the main assembly 5 to position and fix the holding body 4 and the main assembly 5.

In addition, please refer to FIG. 2 and FIG. 3. The all-in-one desktop computer 2 in the embodiment further includes a front cover 7 and a supporting element 8.

The front cover 7 is disposed on the other side of the display module 3 opposite to the main assembly 5 and covers the display module 3, the holding body 4, and the main assembly 5 together with the back cover 6. Further, the display panel 31 of the display module 3 in the embodiment is exposed from the front cover 7. The front cover 7 and the back cover 6 in the embodiment may be made of the same material such as plastic or metal.

The supporting element 8 may be a seat. However, the invention is not limited thereto. The supporting element 8 may connected with the back cover 6 for supporting the all-in-one desktop computer 2 and allowing the all-in-one desktop computer 2 to be placed on a plane, such as a desktop.

In addition, the all-in-one desktop computer 2 in the embodiment can use a plurality of fixing elements to pass through a plurality of through holes disposed at edges of the holding body 4, the back cover 6, and the front cover 7, thereby fixing the holding body 4 and the display module 3. Further, the front cover 7 and the back cover 6 cover the display module 3, the holding body 4, and the main assembly 5 together from two opposite sides. Thereby, the volume of the desktop computer is reduced, and structure stability of the all-in-one desktop computer 2 is strengthened.

Therefore, according to the all-in-one desktop computer 2 in the embodiment, the main assembly 5 is disposed at the holding body 4 to position and fix the electronic components of the main assembly 5, and the display module 3 is disposed on the main assembly 5 and the holding body 4, thereby improving speed of assembling the all-in-one desktop computer 2. In addition, the main assembly 5 is effectively prevented from external electromagnetic interference (EMI) by the holding body 4. Thus, additional metal elements are not set for the different electronic components of the main assembly 5 to prevent the EMI, thereby reducing the components to reduce costs.

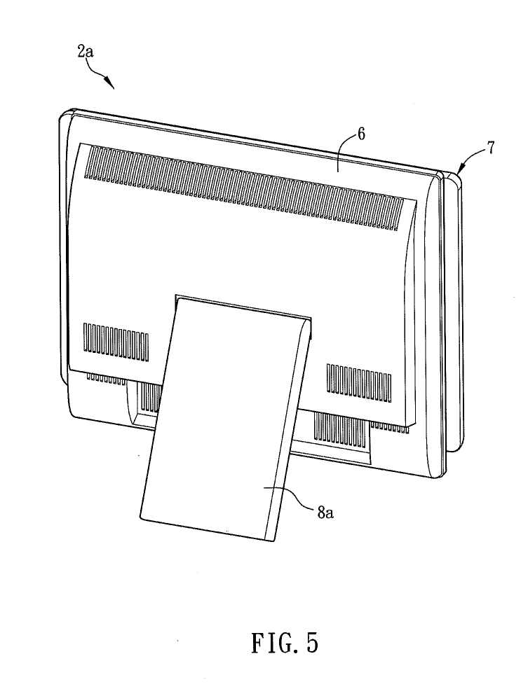

FIG. 5 is a back view showing an all-in-one desktop computer according to one preferred embodiment of the invention. In FIG. 5, a supporting element 8a in the embodiment may be a cylinder or a plate. In the embodiment, the plate is taken for example. However, the invention is not limited thereto. The supporting element 8a is disposed at a back cover 6 for supporting an all-in-one desktop computer 2a and broadening application range of the all-in-one desktop computer 2a. For example, as the all-in-one desktop computer 2a is supported by the supporting element 8a, the all-in-one desktop computer 2a can be disposed on an uneven surface.

To sum up, according to the all-in-one desktop computer in the embodiments of the invention, the volume of the desktop computer is reduced, and the main assembly is disposed at the holding body to strengthen the structure stability of the all-in-one desktop computer. Further, the main assembly is effectively prevented from the external EMI via the holding body. Thus, the additional metal elements are not needed for the different electronic components of the main assembly to prevent the EMI. Thereby, the components is reduced to reduce the costs, and assembling efficiency is also improved.

Furthermore, the holding body has a plurality of the displacement portions and the containing portion. The containing portion may position and fix the different electronic components of the main assembly and avoid affecting the position of the main assembly relative to the holding body. The different electronic components of the main assembly may be dissembled or replaced conveniently by the displacement portions. In addition, since the main assembly is fixed relative to the holding body, the display module only needs to be fixed to the main assembly and the holding body, and then the front cover is combined with the back cover to cover the display module, the holding body, and the main assembly. Thereby, time for assembling the all-in-one desktop computer is be greatly reduced thus to improve the assembling efficiency.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An all-in-one desktop computer comprising:
a display module;
a holding body disposed on one side of the display module;
a main assembly disposed at the holding body; and
a back cover covering the holding body and the main assembly, the back cover and the holding body being disposed on the same side of the display module.

2. The all-in-one desktop computer according to claim 1, further comprising a front cover disposed on the other side of the display module, the front cover being assembled with the back cover.

3. The all-in-one desktop computer according to claim 2, wherein the display module is exposed from the front cover.

4. The all-in-one desktop computer according to claim 1, wherein the holding body is made of metal.

5. The all-in-one desktop computer according to claim 1, wherein the main assembly has a motherboard, a data storage device, an optical disk drive, and at least one heat dissipating element.

6. The all-in-one desktop computer according to claim 5, wherein the holding body has a plurality of displacement portions, and the displacement portions correspond to the data storage device and the optical disk drive, respectively.

7. The all-in-one desktop computer according to claim 5, wherein the holding body has a containing portion, and the containing portion contains the motherboard, the data storage device, the optical disk drive, and the heat dissipating element.

8. The all-in-one desktop computer according to claim 5, wherein the heat dissipating element has a heat dissipating fan, a heat dissipating film, a heat dissipating plate, a heat dissipating fin, a heat pipe, or a combination thereof.

9. The all-in-one desktop computer according to claim 1, wherein the main assembly has a central processing unit, a chipset, a universal serial bus connecting port, a card reading port, an audio input/output port, an input interface connecting port, a network connecting port, or a combination thereof.

10. The all-in-one desktop computer according to claim 1, further comprising a supporting element connected with the back cover.
